(19) United States
(12) Patent Application Publication
(10) Pub. No.: US 2001/0051503 A1
(43) Pub. Date: Dec. 13, 2001

(54) System and method of planning and designing a broadband wireless network

(76) Inventor: Christa S. Lush, Lutz, FL (US)

Correspondence Address: Roberts Abokhair & Mardula, LLC, Suite 1000, 11800 Sunrise Drive, Reston, VA, 20191-5302, US

(21) Appl. No.: 09/878,951

(22) Filed: Jun. 12, 2001

Related U.S. Application Data
(60) Provisional application No. 60/210,941, filed on Jun. 12, 2000.

(51) Int. Cl. H04H 9/00

(52) U.S. Cl. 455/2.01

(57) ABSTRACT

The present invention is a system and method of analyzing the market for broadband wireless services (BWS). Existing data is used to identify a high bandwidth customer profile and surveys are used to validate or improve the profile. Next, market information is physically organized. Buildings are located by address from real estate databases and cross-referenced with orthophotographs. Line of sight between buildings and hubs is determined with canopy DEM data. Potential hubs of all wireless providers are located using FCC filings. Overlays are created to identify actual and/or available broadband service. Competing services are also analyzed within the given market. All available service is mapped according to physical location of the customers and analyzed to identify gaps and saturation points for BWS. Optimal hub placement to fill gaps is calculated. Predicted customers are counted and feed into a business model to calculate an average price for service.

### RELATED APPLICATIONS

This application claims the benefit of U.S. Provisional Application Serial No. 60/210,941, filed Jun. 12, 2000 and incorporated herein by reference.

### FIELD OF THE INVENTION

This invention relates generally to market analysis. More particularly, the present invention is a system and method for identifying a customer base needing high-bandwidth data services.

### BACKGROUND OF THE INVENTION

Network Design is a complex affair that has been the subject of investigation by various inventors. For example, U.S. Pat. No. 5,680,325 to Rohner describes a system and method of planning, implementing, and activating a broadband network. An operating support system (OSS) is used to implement the system creation process. Marketing surveys are used to determine long-range demands for broadband use. Concentrations of potential customers are physically characterized by geographic area.

U.S. Pat. No. 5,710,758 to Soliman et al. describes a system and method of planning a wireless telecommunications network. The system allows the user to build a computer model of a network and simulates network use. The user first identifies locations for base stations over the market area. A propagation loss matrix is developed between the base stations and service locations. Demand and service vectors are run according to the population and expected usage. Locations are assigned to base stations providing minimum propagation losses. Sensitivity is calculated for the given assignments. Location and base station matches are analyzed for reverse links where the reverse link power is substantially equal to sensitivity. Base station sensitivities are recalculated using the reverse link power from each location.

U.S. Pat. No. 5,999,908 to Abelow describes a product design system allowing the manufacturer and the consumer to interact throughout the product life cycle. Certain interactions are pre-programmed.

U.S. Pat. No. 5,561,841 to Markus describes a system for planning a cellular network. The system is run by software that allows the user to create a network design. Once designed, the user runs the network through simulations of operating conditions. The simulation includes both network layout and customer mobility models. System performance parameters are then optimized.

U.S. Pat. No. 5,668,562 to Cutrer et al. describes a system for optimizing antenna placement for a radio frequency (RF) system. Particularly, this system is adapted to optimally place antennas in indoor systems located in complex urban areas. Test antennas are placed in the building under scrutiny. A map is created which identifies general floor plans of the building and test antenna placement. Signal strengths are measured by hand for each antenna location.

U.S. Pat. No. 5,598,532 to Liron describes a system for optimizing a computer network. A network is modeled and tested in a computer simulation. Existing topology and traffic flow is gathered from segment collectors.

An article entitled “Managing a Portfolio of Broadband Access Technologies” by Laurie Spiegel, Last Mile Solutions, Telcordia Technologies (2000) describes a method for analyzing the service needs in a communications market area. This article further describes a method that helps the user design a network that economically meets the needs of the market. First, the services and providers in a given market are mapped. Both geographic and demographic characteristics about the desired market are gathered. The highest demands of the market are identified and suggest the best investment for a service provider. Next, communications technologies are examined to determine what service or services best meets the needs of the desired market. Once viable services are identified, a cost analysis of implementing the appropriate network(s) is performed.

A web page of Agilent Technologies (www.safco.com/broadband) describes a variety of services and software for communications network design. Particular to broadband networks, Safco offers to conduct demographic analysis, identify existing capability, design service options, and estimate costs to implement the design.

Safco further provides products and services particular to designing wireless networks. Safco performs a marketing analysis for any selected city and any selected service.

Similarly, the web page for Nortel networks (www.nortelnetworks.com) describes a variety of network planning services and products. Nortel performs a Geomarketing survey. The survey seems to identify potential telecommunications customers in a given area. Customer locations are mapped. The customer may use the survey to contact potential customers.

As can be seen from these references, the process of building a broadband network involves determining many variables that affect usage. Maximizing usage and minimizing costs are essential to making broadband services into profitable businesses. Traditional methods of wireless system design center around the concept of ‘blanket coverage’. Due to the nature of mobile wireless systems, building a network to cover large geographic areas within a market tend to be profitable, although not necessarily the most efficient. The level of detail in locating end users does not need to be very granular due to the mobility of the end user. If people tend to travel throughout a metropolitan area, then mobile wireless service providers need to offer coverage throughout the metropolitan area. However, as companies offering traditional land-line service have to reach each customer's specific location. Knowing exactly where a customer's house or business is located is paramount to the system design.

With the advent of fixed wireless communications, local multi-point distribution service (LMDS) and multi-channel multi-point distribution service (MMDS) systems developed. Broadband wireless systems (BWS), also known as fixed wireless, can service many customers from a single physical location, known as point to multi-point (PMP). They can also choose to service only one high capacity customer from one building, called point to point (PTP). The third option for broadband wireless providers is to design a synchronous optical network (SONET) system. This system services numerous high capacity customers by linking numerous buildings together with a PTP type connection, in a ‘connecting the dots’ type of structure. BWS that utilize higher frequencies are not able to propagate very far due to line of sight issues. These frequencies tend to be blocked by not only buildings and foliage, but also rain and fog. A significant factor in system design is the cost of hardware. In all communication service systems, antennas, receivers, and land lines are expensive to purchase, install, and integrate. In order for a communications system to be cost-effective, a network provider attempts to maximize the amount of usage on all available lines while minimizing the amount of hardware used. Methods of optimizing this process for broadband wireless networks currently do not exist. Instead, providers are building networks where they are able to get leases to buildings, without knowing what customers are in the potential coverage of that building. This process is financially risky since the provider may sign a lease and not be able to generate enough revenue from the surrounding businesses in order to justify the cost of the hardware.

The network provider also attempts to minimize the amount of hardware needed to reach a maximum amount of customers. As an example, for the most efficient use of a single hub, there should be a clear line of sight between the hub equipment and the maximum amount of customers. This is accomplished by locating and selecting areas with concentrations of potential subscribers/customers.

Another problem in designing broadband wireless networks is predicting who subscribers would be with some degree of accuracy. Currently no method exists for creating a profile that identifies people or businesses that are more or less likely to utilize large amounts of bandwidth.

Additionally, providers will also need to know who, if anyone is currently offering competitive services to these customers and what rates are they charging for these services. This information assists in defining competitive pricing plans. It also feeds into the providers' business model in determining financial feasibility of a broadband network in that particular location. A network provider can maximize usage and minimize costs with good system planning. Currently, no tools are available which give the communications service provider necessary information for maximizing usage and minimizing costs when designing a broadband wireless system. In order to solve these problems, a designer needs to know the answers to several questions: Who uses, and/or would like to use, high bandwidth services and where they are located? Where is the existing competition and what type of potential penetration do they have within a market? What are the zoning and leasing issues that need to be dealt with for buildings within a market? How many high bandwidth users are located within the same buildings? What are the shapes of buildings as well as the height's of the buildings and surrounding foliage? The answers to all of these questions are extremely important when designing a broadband wireless network.

### SUMMARY OF THE INVENTION

It is therefore an objective of the present invention to determine target subscribers of high-bandwidth communication services.

It is another objective of the present invention to determine concentrations of target subscribers in a given area.

It is yet another objective of the present invention to design a communications network where current and potential customer usage is maximized.

It is a further objective of the present invention to precisely identify the geographic location of customers of a high bandwidth communications network.

It is yet another objective of the present invention to precisely locate all communication network capabilities provided in a specific area to create an inventory of existing capability and lack thereof.

It is yet another objective of the present invention to link orthophoto databases and real estate databases to support network system design.

It is another objective of the present invention to identify building parameters needed for communication system design.

It is a further objective of the present invention to create a profile of a typical high bandwidth customer.

It is a further objective of the present invention to design, deploy and maintain highly targeted telecommunications networks.

It is yet another objective of the present invention to identify businesses that use a high amount of bandwidth but who do not use fiber for those needs.

It is a further objective of the present invention to create a geographically based model that can be used to identify high bandwidth users.

It is another objective of the present invention to identify users by building who have the highest probability of being high bandwidth users.

It is still another objective of the present invention to be able to better develop market strategies and deployment plans for creation of high bandwidth networks.

It is a further objective of the present invention to increase the accuracy and efficiency of designing a high bandwidth network.

It is still another objective of the present invention to assist designers in locating communications hubs in areas where there is a high concentration of potential users for high bandwidth communications.

It is another objective of the present invention to reduce the cost and time to build an efficient broadband network.

It is yet another objective of the present invention to assist in sales and marketing of hardware and software to businesses that utilize high bandwidth communications.

The present invention is a system and method of analyzing the market for a broadband wireless network, and for planning and designing an optimized network to serve the market. An analyst uses available marketing information to establish a baseline of customers using high speed cable and/or fiber optic services in a given area. The analyst examines the listings to identify customers who use high bandwidth services. A profile of high bandwidth users is developed. More detailed marketing profiles are obtained for the identified customers. The profile is checked for accuracy and revised, such as quarterly or until it is about 85% effective. The desired market is then characterized physically. All buildings within a market area are located by address available from real estate databases. These addresses are cross-referenced with high resolution orthophotographic databases to identify precise building locations. Existing, planned for, and potential hubs of wireless providers are located using FCC filings. Overlays are created in a geographic information system and placed on the map to identify actual and/or available broadband service. Site teams canvas the market and compare actual building and antenna locations with those identified in the records obtained.

Competing services are also analyzed within the given market. All available service is mapped according to physical location of the customers. Competing wireless and landline broadband services are all compared to identify gaps and saturation points for broadband services. Gaps identify target areas for customer development. Optimal tower placement is calculated for target areas. Predicted customers are counted within the target area, and an average price for service is developed, thereby giving rise to a total system design.

### BRIEF DESCRIPTION OF THE DRAWINGS

FIG. 1 illustrates the general process flow of the present invention.

FIG. 2A illustrates the process flow for determining target subscribers.

FIG. 2B illustrates the process flow (cont.)

FIG. 3 illustrates the process flow for generally examining competition.

FIG. 4 illustrates the process flow for examining wireless service competition.

FIG. 5 illustrates the process flow for examining land line service competition.

FIG. 6 illustrates the process flow for examining ISP service competition.

FIG. 7 illustrates the generalized architecture of the present invention.

FIG. 8 illustrates the broadband entity relationship model of the present invention.

FIG. 9 illustrates the competitive potential flow chart.

FIG. 10 illustrates a map of parcels with attribute data.

FIG. 11 illustrates determination of path length on a map.

FIG. 12 illustrates another map of parcels with attribute data.

FIG. 13 illustrates a wideband market analysis of San Diego using the present invention.

FIG. 14 illustrates a DSL coverage map of Dallas useful for determining broadband gaps.

FIG. 15 illustrates an orthophoto depiction of an area with uncorrected geocoded building locations.

FIG. 16 illustrates an orthophoto depiction of an area with ortho-corrected building locations.

FIG. 17 illustrates the differences between uncorrected geocoded building locations and ortho-corrected building locations.

### DETAILED DESCRIPTION OF THE INVENTION

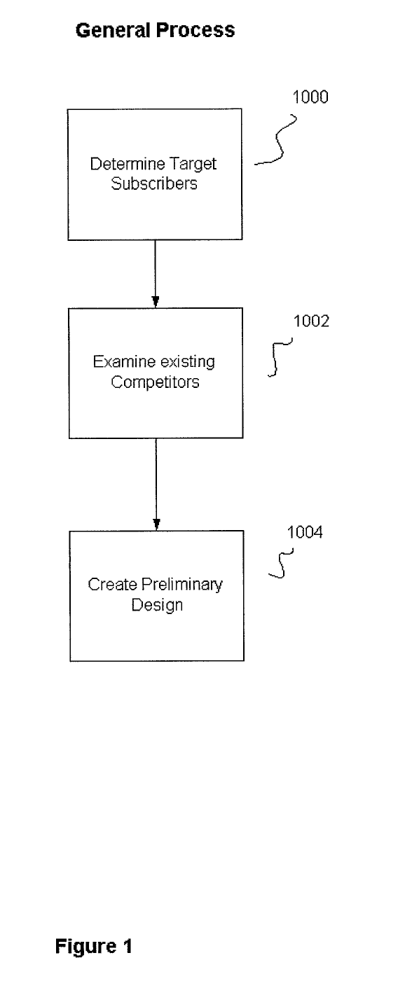

Referring to FIG. 1, the general process flow of the present invention is illustrated. In order to determine the market driven design for the broadband services of the present invention, the system first determines who the target subscribers to the present invention would be 1000. This constitutes a generalized model derived from extensive research as will be described below, and determines which businesses are those that are most likely to need broadband wireless service.

Once target subscribers are determined for a particular area, competition for broadband service within that specific area is then analyzed 1002. Since it is quite possible that certain subscribers might be served by existing broadband communication networks, it is necessary to determine not only what the competition is for the targeted subscribers, but also where competition is physically located.

Once the subscribers and the competition information is developed, a preliminary design can be made 1004, which optimizes the layout of the broadband wireless network in view of the competition and the potential targeted subscribers.

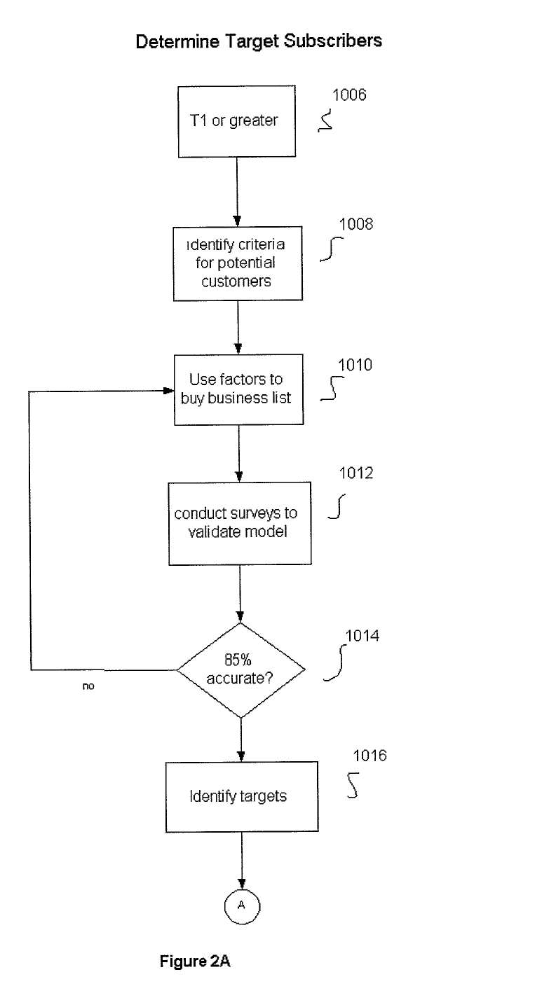

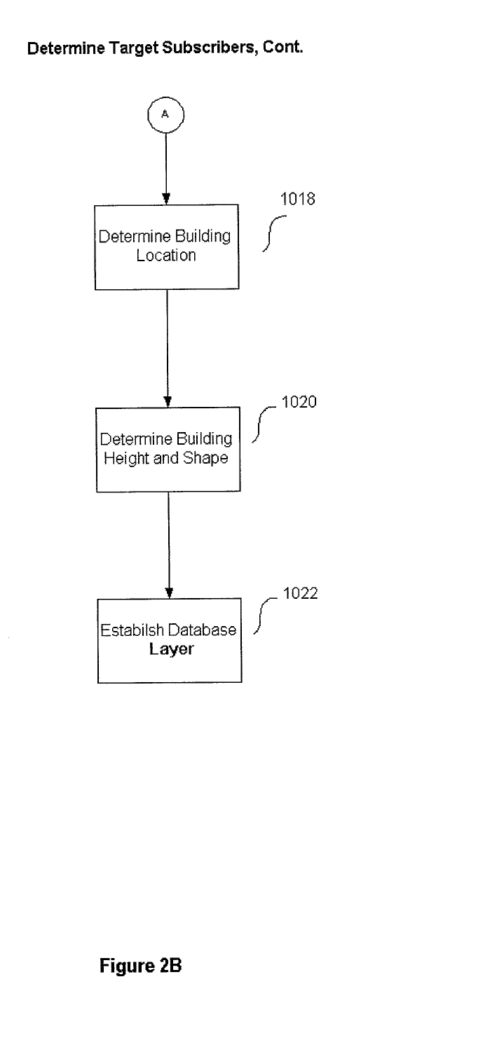

Referring to FIGS. 2A and 2B, the process flow for determining target subscribers is illustrated. Beginning in FIG. 2A, the system of the present invention initially retrieves information concerning who is using broadband services 1006. For example, third party database providers such as IRG (now Harte Hanks, 3344 N. Torre Pines Ct., La Jolla Calif., 92037) provide, for the present invention, a database of businesses that utilize T1 lines or greater bandwidth. This source is not meant as a limitation. Other third party providers will be appropriate as for additional information for the present invention. Any such third party database that has information concerning the various businesses using high bandwidth services will be suitable. A key aspect of the present invention is to identify the various criteria associated with companies that use high bandwidth services 1008.

With the identification of the business criteria, business lists are purchased 1010 and entered into the database. The business lists are specified based upon the criteria identified in the prior step 1008. However, this business list relates to the specific geographic area in which the broadband network is to be developed. The purchase of the business list 1010 is specified to the third party database provider so that only those businesses meeting the criteria identified above are provided.

Once the businesses having the appropriate characteristics are identified, a survey is conducted of the businesses 1012 to determine if they are interested in potentially obtaining broadband communications services. If answers are positive (for example) for about 85% of the subjects surveyed 1014, the appropriate business targets are identified 1016 and the model is considered to be validated. If however, the model is not of the desired accuracy, additional factors are specified based upon the survey results and incorporated into the model. Additional listings of businesses are purchased based on this new model 1010 and surveys will be conducted 1012 to validate the new model. Again, once the model reaches about 85% accuracy, although this is not meant as a limitation, targets are identified and the process continues. Additionally or alternately, the model can be updated quarterly.

Referring to FIG. 2B, the process of the present invention continues. Once targets have been identified as noted above, the actual building location of the potential business targets is determined 1018. This is not a straightforward determination since the physical location of buildings can vary dramatically from where they appear based on certain street databases and/or the type of GPS unit some companies utilize in determining building locations. The present invention determines building locations utilizing orthophotos, and ground surveys.

Once the buildings are located, it is also important to determine the height and shape of the buildings 1020, since the line of sight for broadband communications in a wireless mode is critical. It is important that trees or other above ground obstacles not obstruct the line of sight. Therefore, a database of the building shape is created 1020 and stored in a database layer of the present invention 1022. Associated to each building shape is the above ground height of each building as determined by the canopy digital elevation model data (canopy DEM).

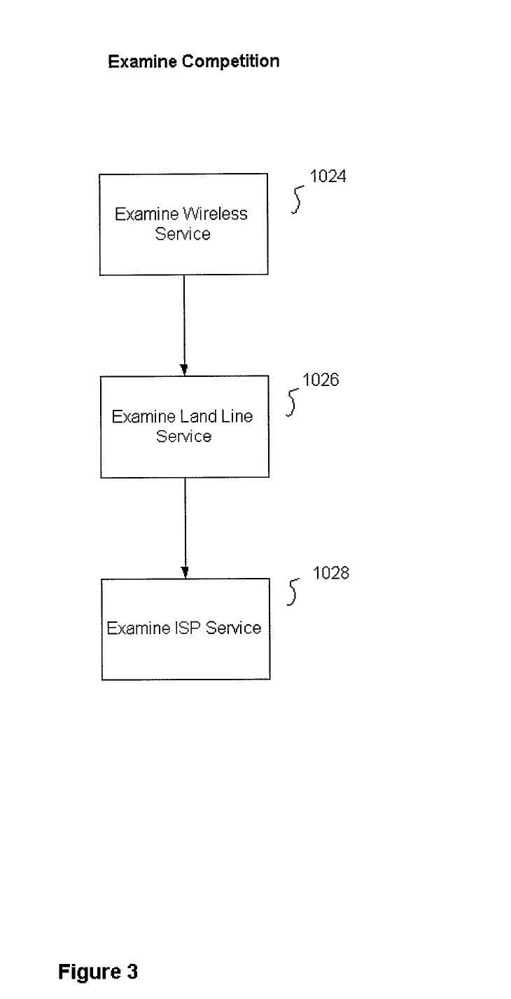

During the course of establishing the potential roots and scope of a new broadband communication system, it is important to examine the competition. Referring to FIG. 3, the general scheme for examining competition is illustrated. First, wireless service in the area is examined 1024. A database of the physical extent of wireless communication services is then established. The extent of landline service is next established 1026. This landline service is the broadband landline service that would potentially compete with broadband wireless communication services. Once the landline service competition is established 1026, a database layer depicting that service is established. Finally, ISP service to the area in question is examined 1028. These various examinations are explained in more detail below.

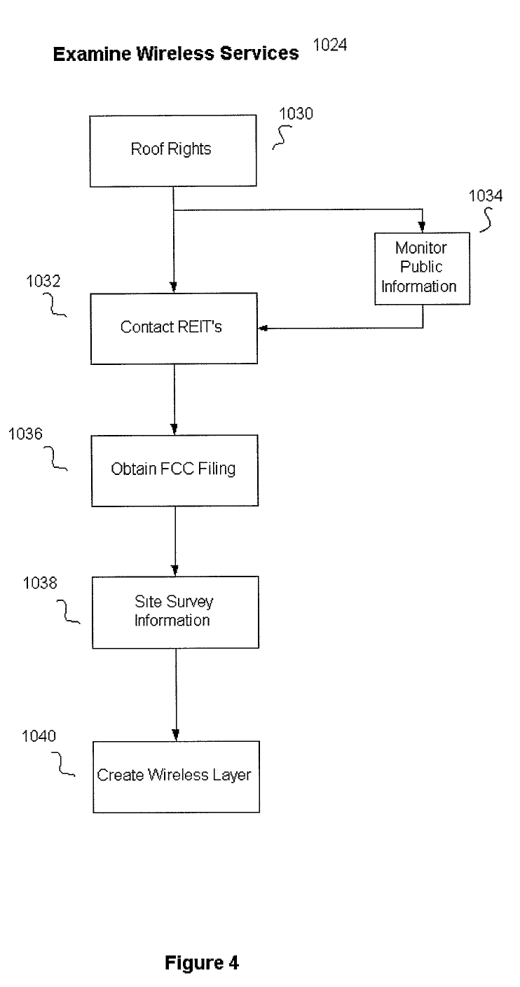

Referring to FIG. 4, the specific scheme for analyzing wireless service competition is illustrated 1024. A database of providers having “roof rights” to each building in an area is established 1030. A wireless service database is built in part from information contained in real estate investment trust (REIT) agreements 1032. This information may be gathered by database subscription or by hiring a research company to collect the desired information. Possible companies to investigate are additionally tracked by monitoring public records and press releases 1034 and stored in the wireless service database. The wireless service database further includes information on possible competitors gathered from Federal Communications Commission (FCC) filings 1036. These filings are stored in public records. This establishes all possible and actual wireless services available for a given area.

The accuracy of the wireless service database is refined by performing site surveys 1038. The wireless layer in the GIS is created by correlating actual wireless services to building locations within the given area 1040. This information is validated through the site surveys, which are performed through field research within each market.

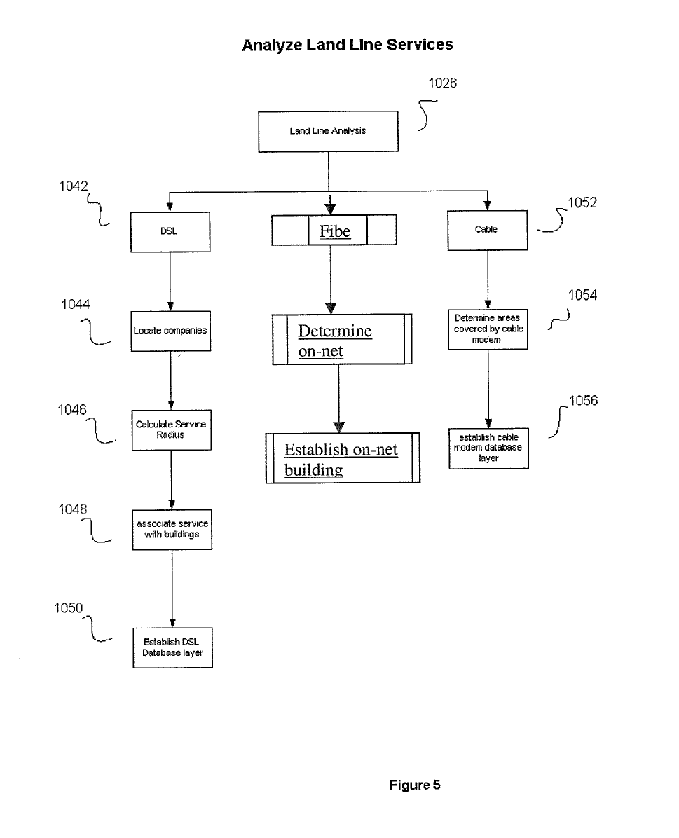

Referring to FIG. 5, the specific scheme for analyzing land line service competitors is illustrated 1026. Land line services include Digital Subscriber lines (DSL), fiber optic service, and cable modem service. DSL service is provided via a land line system. This service is distance restricted and thus service availability varies depending on the customer location to the central office serving the customer. The quality of service a DSL customer receives increases the closer the customer is to the central office where the DSL equipment is located. DSL service is further limited by the boundary of the wire center serving area.

To evaluate DSL service, all DSL service companies in a given area are stored in a database 1042. Locations of central offices and wire centers are mapped 1044. A calculated service distance for all central office locations within a given area is determined 1046. The service distance is calculated from the central office along all roads potentially carrying the cable. Any buildings along roads designated as potential DSL service areas will be assumed to have access to DSL services. There are varying levels or grades of DSL service. Very high data rate DSL (VDSL), High data rate DSL (HDSL), Asymmetric DSL (ADSL), and Symmetric DSL (SDSL). Currently, of these, only ADSL service is being offered, due to technology restrictions. VDSL and HDSL are theoretically possible, but equipment does not currently exist for sale to offer these levels of service. Each road segment is then correlated to the specific type of DSL service 1048 potentially available.

DSL service types and locations form the DSL layer for the area 1050. Pricing information for each service may further be included (not shown) for each service area and stored in the DSL layer of the GIS database.

The analyst must further evaluate land line competitors by analyzing cable modem service 1052. Evaluating cable service is difficult because multiple providers can offer service in an overlapping region. But they cannot compete for service within the same business and/or residence. Currently there does not exist a boundary or region that delineates which areas receive cable service from which providers. Cable providers within the given area are identified and stored in the database 1054. The cable layer 1056 is formed by associating areas covered by cable providers and is stored in the GIS database.

Another database contained in the landline analysis is the probability of fiber optic cable within a building; also called an on-net building 1058. Determining the existence of fiber within a building is a key factor in analyzing potential hub candidates for broadband wireless networks. The hubs need to be located on roofs of buildings that are equipped to handle the amount of traffic being received by that hub and channel that traffic to the landline architecture. Cable wiring is not sufficient to handle this amount of traffic. Also, currently there is not a database in existence that details which buildings have fiber in them and which do not. The present invention utilizes the NPA and NXX (area code and exchange) for the businesses within each building. These numbers are compared to central offices providing service to each business. Any NPA/NXXs that are serviced by competitive local exchange carriers (CLECs) will be utilizing fiber. This is because these companies were unable, due to FCC regulations, to offer service prior to 1996. As a result, no one deploying landline services in today's markets will install anything but fiber. Copper cable, which was the medium used for the existing infrastructure of the incumbent local exchange carriers (ILECs) no long makes financial sense when constructing new lines. Fiber is far superior to copper. And with bandwidth demands growing, copper is insufficient to support this growth. Determining the buildings containing fiber provided by the ILECs utilizes a methodology based on the individual switch codes that service each CO. Which COs run fiber is determined by switch number. The present invention also determine which exchanges are assigned to which CO. By locating businesses in buildings with NPA/NXXs that are serviced from switch's running fiber, we determine which buildings have fiber being utilized within 1060. This methodology is validated by a combination of surveying the building owners and performing on-site building studies 1062.

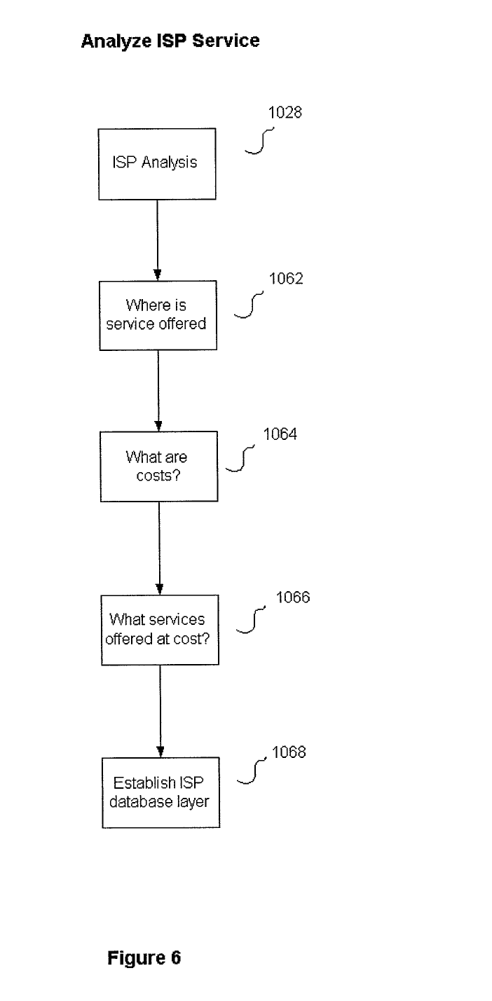

Referring to FIG. 6, the specific scheme for analyzing ISP competition is illustrated 1026. Locations of known ISP service providers are stored in the ISP database 1062. Costs for each provider are identified and stored in the ISP database 1064. Marketing surveys are conducted to determine costs associated with various ISP subscriptions. Costs are further identified according to types of subscriptions, such as residential or business, and associated price. Marketing results are stored in the ISP database 1064, 1066. Available service, provider, and associated costs are correlated to the physical locations of houses and buildings to form the ISP database layer 1068.

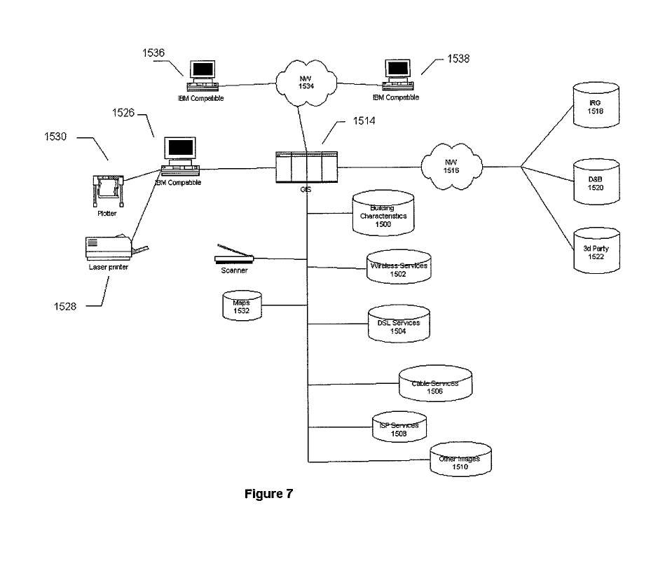

Referring to FIG. 7, the overall generalized architecture of the present invention is illustrated. GIS processor 1514 comprises the model (noted above) and other software for administering the system as noted above. In order to process and design the network architecture of the present invention, processor 1514 accesses various databases such as building characteristics database 1500, wireless services database 1502, DSL service database 1504, cable service database 1506, ISP service database 1508, other images 1510, and fiber database 1512 that may be used to visually overlay with any of the other databases in depicting the network desired. Additional input is provided via maps 1532 and, where necessary, scanned images are input via a scanner 1524.

Processor 1514 is connected to a network 1516 in order to obtain third party databases such as that from IRG 1518, Dunn and Bradstreet 1520, and other third party sources 1522. This information is retrieved over network 1516 for subsequent processing by processor 1514. Output of proposed network designs are provided to workstation 1526 for visual display or to be printed 1528 or plotted on plotter 1530.

It is also anticipated that the processor of the present invention can be accessed remotely over any network 1534 by subsequent remote workstations 1536 and 1538.

It should be noted that networks 1534 and 1516 may not necessarily be different. For example, access to the processor 1514 may be accessed over the network in which case the processor 1514 is connected to the Internet and remote terminal that are authorized to access the system can access the system via the Internet.

It is anticipated that processor 1514 comprises 3 high end, IBM-compatible servers. One server would run the database software (Oracle or a similar spatial database), one would store all databases of the present invention and the third would run the various software programs required to operate the GIS and perform the queries, maps, analysis and reports. The systems would be operating via Windows NT®, UNIX®, or any other suitable operating system known in the art for use with geographic information systems and spatial database analysis.

Thus using the system of the present invention, a company desiring to establish a broadband wireless network would specify the area in which it would like to create the service. Using the refined model of the present invention, the system identifies the businesses that are the most likely candidates for broadband service. The locations of those businesses are then precisely established. Building information for the area desired is established with the precise shape and location of the buildings within the area. The potential customers are then associated to the buildings in which they reside. Other data sources are used to establish other physical characteristics of the area such canopy DEMs and the like.

The competing networks for the proposed service are analyzed and stored as spatial layers within the database of the GIS of the present invention.

With this information, a system owner can analyze the physical characteristics of the proposed networks and make informed recommendations as to where the best locations for hub candidates and customer premise equipment (CPEs) would be to best serve the area. All of this design is keyed to the businesses that are the most likely buyers of such a service.

One aspect of the present invention is the solicitation of information via a questionnaire, which is obtained from various companies in an area that is a potential target for broadband wireless development. The questionnaire looks at the company's geographical location to determine how wireless can best serve the company. The factors that determine suitability are in part, the size of the company, the growth or possibility thereof which may change the needs of the company, the connection and the speed of company's current data access provider, or lack thereof. Such factors may make the proposed broadband wireless connection more or less useful.

Connection speeds of various providers can vary from DSL, T1 or T3. A fractional T-1 or T-3 line is a T-1 or T-3 digital phone line in the North American T-carrier system that is leased to a customer at a fraction of its data-carrying capacity and at a correspondingly lower cost. Digital subscriber line (DSL) promises speeds more than 250 times faster than analog modems over regular phone lines. These different connections may increase or decrease the company's output and, if present, can affect a company's desire for broadband wireless services.

A connection is usually done through copper, fiber or wireless. That is, the choices range from telephone line, cable lines or wireless (being just that). These different connections are vastly different in terms of speed, in relation to data transfer and in terms of reliability.

Another important factor to users is cost. This should be accounted for in determining what are the company's present needs and what connection is going to best serve the company now and in the future. The cost, speed and reliability may depend on how the company's system operates. Is the company's connection separate, meaning that it only is used to transfer data, or is it used in conjunction with voice transfer. If the company is involved in minimal data transfer the sharing of the same network does not hamper the company's connection quality. However, if there is a large amount of data transfer then there is a greater need for a wireless system.

The demands exerted on the company's connection may depend on the configuration of the company. Is the company located in one compound, a campus setting, or is the company made up of a headquarters and branch offices? Depending on this configuration, the system that the company uses may need to geographically narrow or widen.

The VPN (virtual private network) is a private data network that uses public telecommunication infrastructure, whereas the WAN (wide area network) is a geographically dispersed telecommunication structure from a local area network. These choices may then be compared with a wireless connection. These options should be explored so that the needs of the company are best satisfied. How does the company decide what system best suits the company's needs? A determination should also be made of the company's daily activities; data transmitted daily, use of video conferencing and does the company have a website and how much traffic accesses that website during given periods. Does the company believe that the company's current system can grow with the company?

The optimal value of this invention would be:

A company that transfers large amounts of data, such as an e-commerce business, that may be located in a discreet area but has a high traffic input and output may be ideal candidates for broadband wireless services. Important factors include the daily output. This is not necessarily measured by the size of the company but rather by the daily data transfer demands put upon a system. A company that still combines voice transfer and data transfer on one system creates delays and backlogs.

To minimize cost a company needs to maximize use, that is, a single tower should service an optimal amount of customers. To maximize use of a single tower there needs to be a clear line of sight between the antenna and the maximum amount of customers. Reception can become less efficient in an area populated by tall buildings, or other obstacles that could block the signal. This geographical factor translates into maximum use in a populated area that is not developed into a high-rise area.

Another factor is to investigate current use of wireless in an area. Competing services may show an interest in a given area for wireless service, identifiable gaps in a given area or the saturation of that area making it undesirable to invest further resources.

If an area has already been laid with fiber optic cable to service the area then there is going to be minimal need for a wireless system. Fiber optics can carry large amounts of data and adding a wireless system would saturate the area making the establishment of such a system not cost effective. A wireless system is cost effective when a minimal amount of hardware services a maximum amount of customers. If that balance is not reached then the cost of service rises and the minimal call for a wireless system is negated by high costs. Also, an area that has already been made fiber optic ready makes it more cost effective for the customer to tap into the fiber optic system, rather than employing a costly wireless system.

If an area has a low population there still may be a demand for wireless service, however, such service would be costly. Towers are uni-directional and can only service customers within its sector. That means that there is a discreet area that any given tower may service. Since there is this restriction on use and the need to be cost effective; areas of low population would be too costly.

Similarly, these uni-directional towers that service a discreet area may leave those on the fringe without service, that is anyone outside that sector cannot be serviced, unless a second tower is erected. And again, it would not be cost effective to erect a second tower for a few users.

If a company is set up in a campus setting and large amounts of data is transferred, whether it be inter-office or globally, the construction of a wireless system to service that area would be economically feasible.

If a company is using a VPN (virtual private network) there are two forms of communication. One form is through the phone lines utilizing the shared public infrastructure; which lowers the costs of transmission. The other form is the use of wireless through a shared public infrastructure. If a company is growing the use of the grounded VPN may slow down your communications. A high broadband allows more information to be piped through without an increase in the amount of time it takes to send or receive.

If a company engages in international business endeavors and utilizes technology, such as video conferencing there needs to be a reliable and strong connection. That company needs a wireless system, which would allow it to access a connection that would not be slowed down by heavy traffic. The company is best served by a system that can handle effectively high traffic.

Responses to these areas of the questionnaire give valuable input information to the model described above.

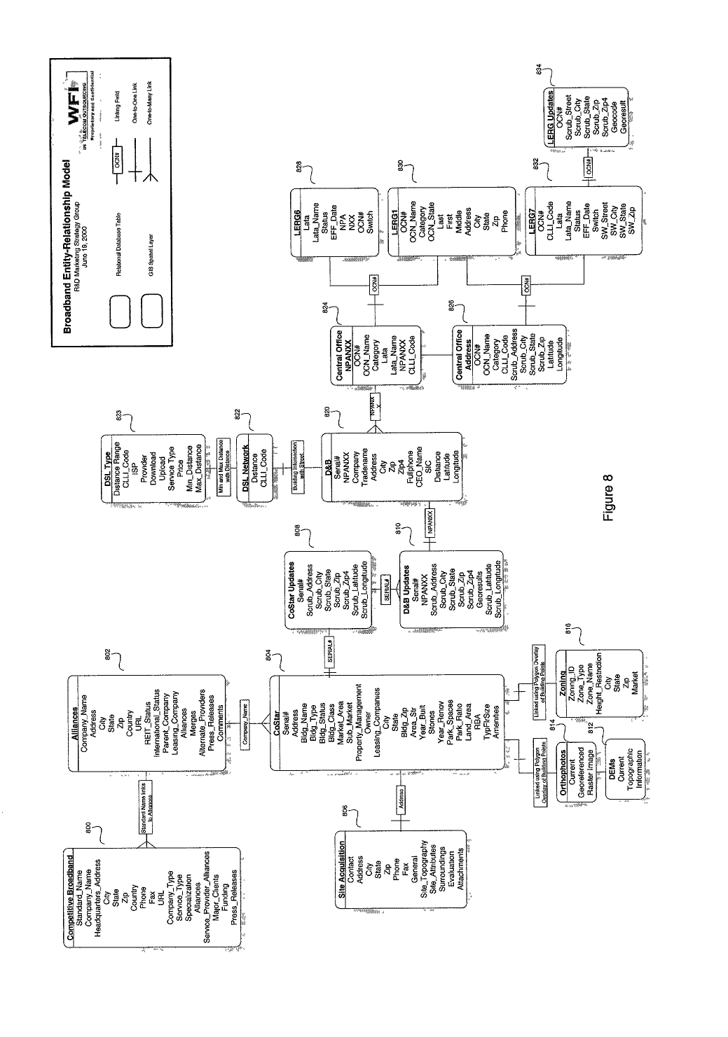

Referring to FIG. 8, the broadband entity relationship model of the present invention is illustrated. Various broadband providers are noted 800 and stored in a database of competitive broadband providers. Information, such as the company name, its location, its services that it provides, major clients, and other information, are stored concerning multiple broadband providers. Certain of these companies may, in fact, engage in activities in an alliance. Where this is the case, an alliance database 802 is stored comprising the company names, their parents, various alliances, and other information necessary to determine the members of the alliance. This alliance information 802 is combined with a real estate database such as the COSTAR database 804 available from COSTAR Group, 2 Bethesda Metro Center, 10th Floor, Bethesda Md. 20814, which provides information on various buildings in the area of interest. The COSTAR information 804 is combined with various spatial data, such as current topographic information 812, orthophotos comprising current georeferenced raster images 814, zoning information 816, which are all referenced to individual buildings in the COSTAR database. Candidates for broadband wireless hubs are identified and stored in a site acquisition database 806.

The COSTAR information 804 comprises periodic updates 808, which update the latitude, longitude, address and other locational information of selected buildings. Businesses within those buildings are the subject of Dunn and Bradstreet updates 810, which businesses are also reference to latitude and longitude. The Dunn and Bradstreet updates 810 are fed information regarding the type of broadband service that is available, such as DSL 823 and information concerning the DSL network 822 that serves a particular company in a particular location. This forms a D & B database comprising the company, trade name, address, telephone, and latitude, longitude information 820. Central office information associated with the D & B database 820 is provided. This central office information 824 comprises the name, category, and other information concerning the service provided. The central office address 826 is associated with the central office database 824 as are a variety of local exchange routing guide (LERG) databases 828, 830, and 832. Information in the LERG databases is also provided with periodic updates 834.

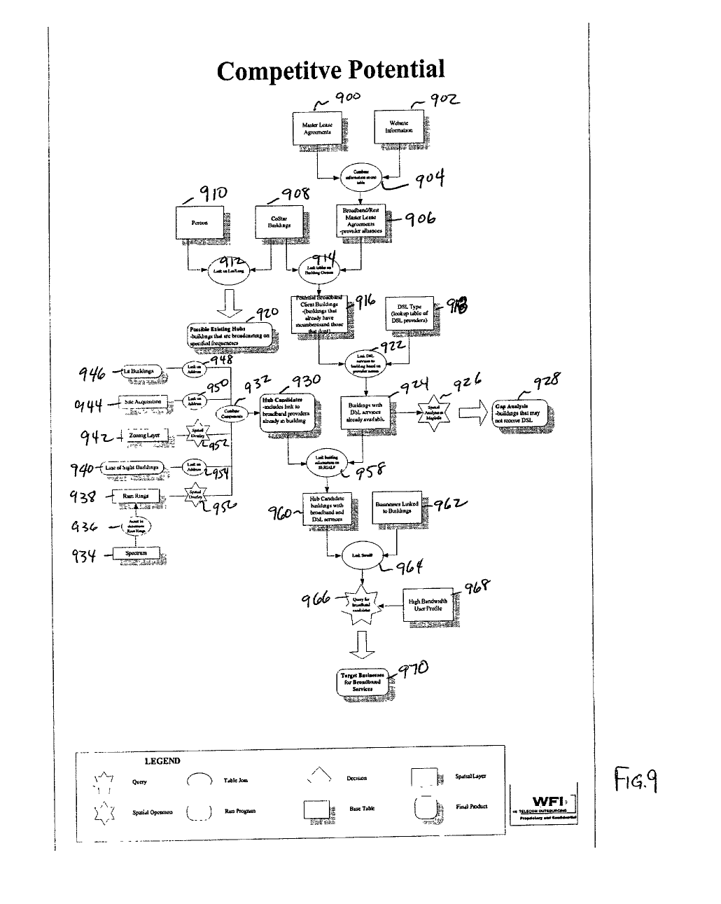

As noted above, the purpose of the present invention is to create a competitive potential report on or concerning which businesses may be candidates for broadband services. The system of the present invention brings together a wide variety of disparate information in order to determine the potential for broadband services needs. Referring to FIG. 9, the competitive potential flow chart is illustrated. Master lease agreements 900 and web site information 902 are combined 904 in order to yield a table 906 of master lease agreements, broadband availability, and provider alliances. The system also accesses the COSTAR series of databases 908 to obtain information on individual buildings in an area of interest. The COSTAR database information 908 and the broadband master lease agreement data 906 are linked together 914 to create a table of potential broadband client buildings 916, which comprises a listing of buildings that already have broadband service and those that do not.

Using RF emission information such as PerCon information 910, available from PerCon Corp. of 4906 Maple Springs/Ellery Rd., Bemus Point, N.Y. 14712, comprising information concerning buildings that appear to be broadcasting radio frequency together with COSTAR building information 908, such information is linked 912 to create a listing of possible existing hubs comprising buildings that are broadcasting on specified frequencies that are indicative of broadband service. This table of possible existing hubs 920 is stored in the database of the present invention.

Potential broadband client buildings 916 and information concerning DSL service available in the area 918 are linked together 922 to create a table of buildings with DSL services 924, which are currently available.

The listing of buildings with DSL service currently available 924 is converted via a spatial analysis 926 in order to combine the DSL building information with a map information database to provide a spatial representation of those buildings having DSL service and those that do not. This forms a gap analysis 928 noting specifically those buildings without DSL service.

As part of the overall competitive potential analysis, candidates for wide band wireless hubs are created. Lit buildings 946 are linked to an address file 948. Site acquisition information 944 is also linked to an address file 950. A zoning layer 942 is created comprising the outline of various zoning areas. This is converted to a spatial overlay 952. Line of sight buildings 940, which are buildings that have a clear line of sight unobscured by terrain or otherwise 940 are linked to an address file 954. Rain fade limits or “rain rings” 938, defined by the maximum distance allowed by rain fade, are combined with spectrum information 934 that assists in determining rain rings. The rain rings are formed into a spatial overlay 956. The various spatial overlays 956, 952 and information linked to address are all combined 932 to create a series of hub candidates 930. The hub candidates 930 include links to broadband providers that are already in the various buildings that are potential candidates. The hub candidates 930 and buildings having DSL services already available 924 are joined together 958 to provide a table of hub candidates 960 already having broadband DSL services.

Businesses in the area are linked to specific buildings 962 and are combined 964 to create a spatial overlay 966 of those businesses located in buildings that are candidates for broadband services. This spatial operation 966 is manipulated to determine the specific businesses that may be candidates based upon a high bandwidth user profile 968. The end result is a table of targeted businesses for broadband services 970.

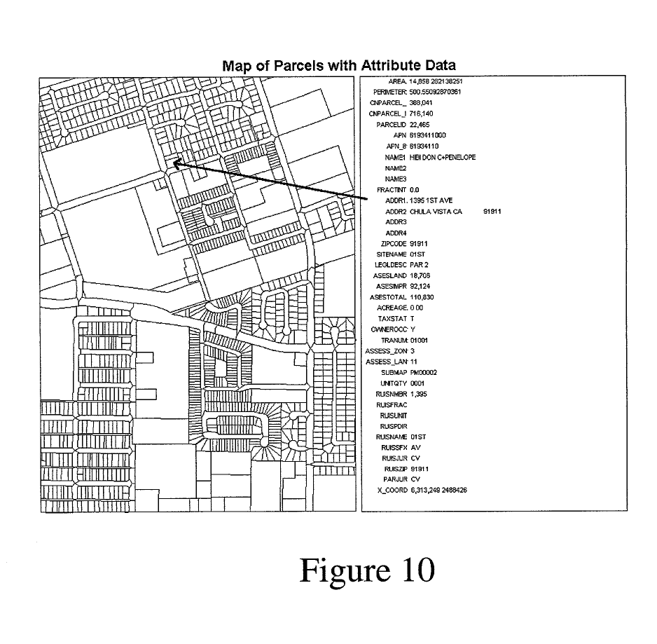

Referring to FIG. 10, a map of parcels with attribute data is illustrated. In this example, a geographic overlay outlining all parcels of land in a region to be analyzed is illustrated. A user can simply highlight a particular parcel of land and a display of attribute data associated with that piece of land is automatically shown. The attribute data comprises such information as the owner's name, address, whether the land is owner-occupied, map location, and a variety of other information.

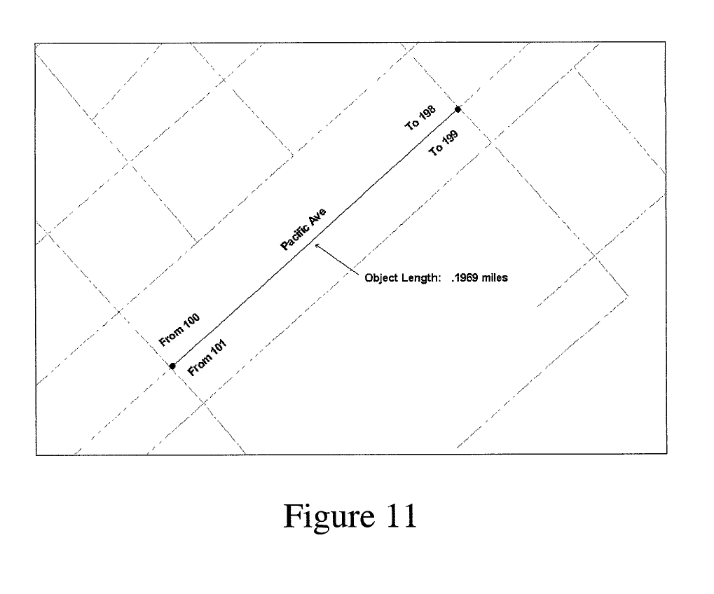

Referring to FIG. 11, the ability to determine a path length is illustrated. A user simply highlights two points on a geographic reference layer of the GIS of the present invention to give a length in miles or any other units desired for a particular communication path.

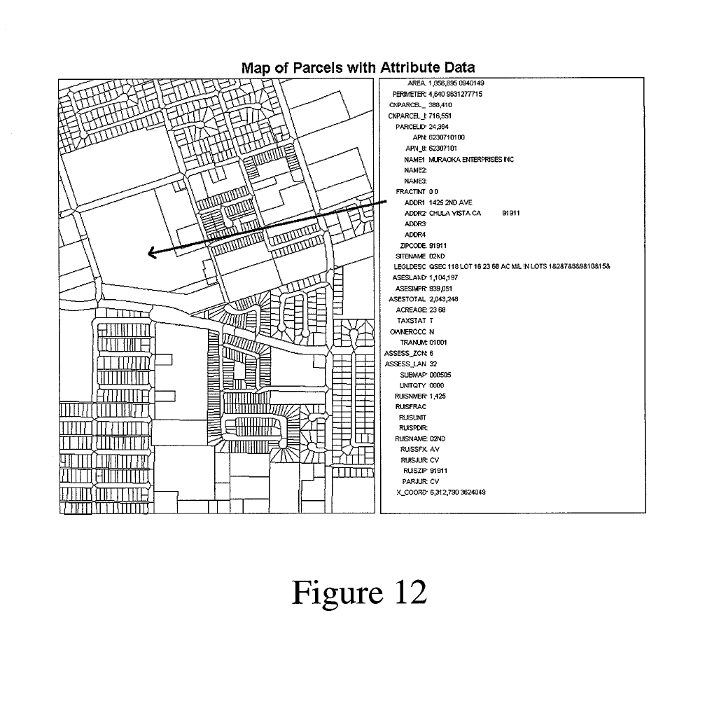

Referring to FIG. 12, yet another illustration of map parcels with attribute data is illustrated. In this instance, a different parcel of land is highlighted and attributes for that land are displayed.

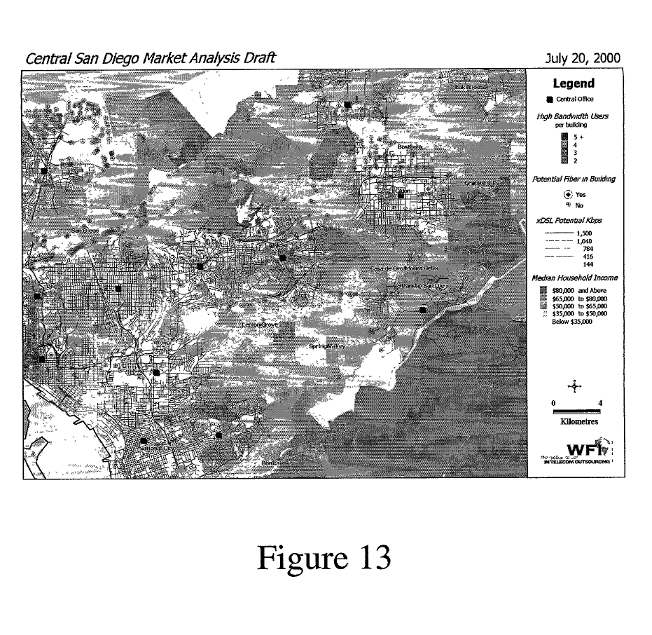

Referring to FIG. 13, a wide band market analysis example is illustrated. In this illustration, the central San Diego market for high bandwidth users is illustrated. Using the system and method of the present invention, a visual representation of the number of high bandwidth users per building is illustrated. Using different color representations the number of high bandwidth users per building is illustrated along with whether or not fiber optic cable is a potential for any particular building. In this fashion, a series of individual buildings are shown together with their potential for having high bandwidth users and whether or not there is the potential for competing services within the building.

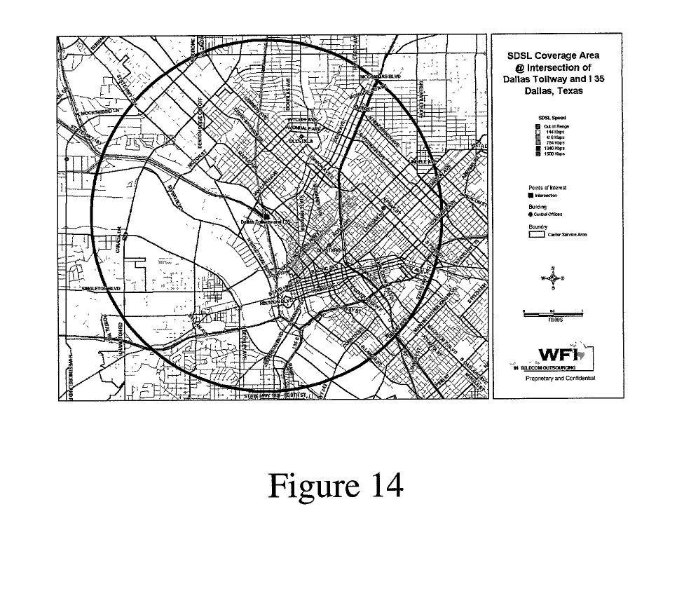

Referring to FIG. 14, DSL coverage for a particular area in Dallas, Tex. is illustrated. Various individual buildings are depicted on the map as having various high bandwidth coverage at different rates depicted as a series of different colors or shades of gray on the map. Thus, at a glance, an individual can determine which buildings have what type of DSL service.

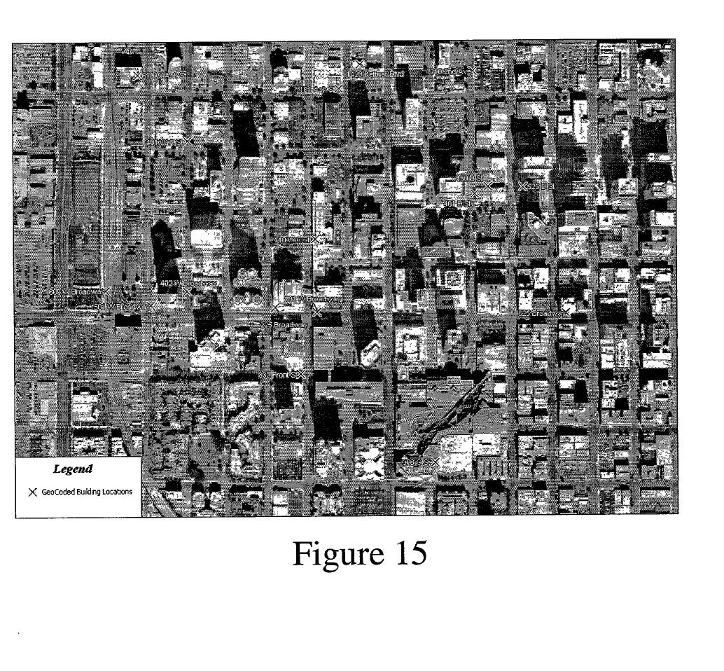

As noted earlier, an orthophoto record of building locations is created. This is necessary, since the location of various features on a building may be incorrect. FIG. 15 shows the location of buildings before correction. Addresses of the buildings are noted and certain geographic locations are associated with those notations. However, certain of the geographic locations are inaccurate. This can be seen since certain addresses appear overlaid on the buildings while other addresses appear to be in the middle of the street.

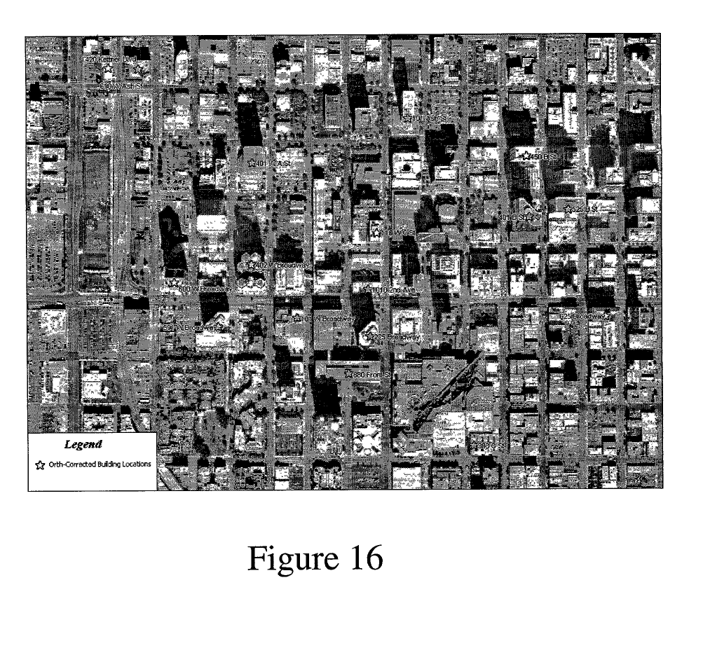

Referring to FIG. 16, the building locations after correction are noted. In this illustration, a star is used to depict the building addresses located specifically on the building whose address is depicted. Thus, rather than having a particular location fall in the middle of a street, the actual location falls on the image of the building in question.

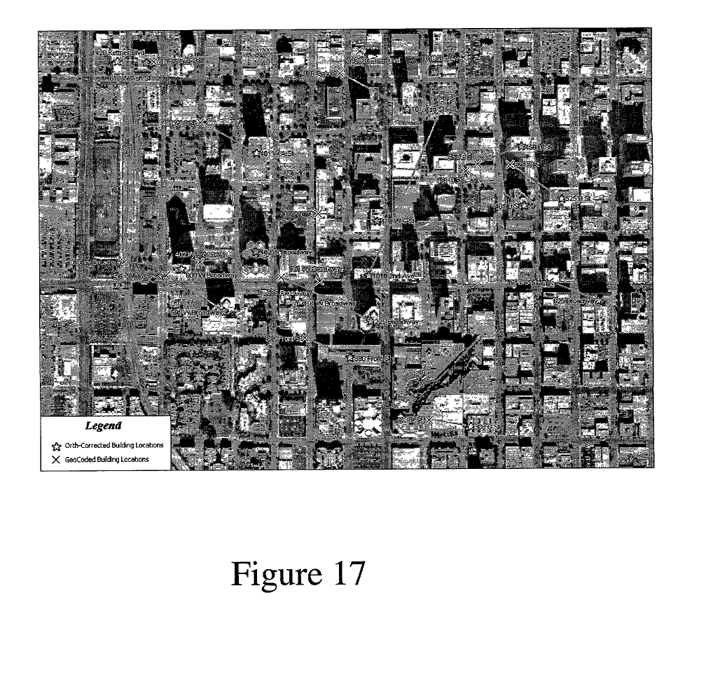

Referring to FIG. 17, the location differences are illustrated. In this illustration, it can be seen that the address is much more accurately represented by the various star locations. In some cases, the address errors are quite significant. Thus, by making the corrections indicated, a much more accurate representation of the location of potential hubs, location of DSL service in buildings, and a host of other physical identifying features are more accurately depicted. This corrected building location is stored in the database and used to create the analysis of the high bandwidth service required.

In a typical embodiment of the present invention, a bandwidth usage database, such as from IRG, is analyzed to detect trends or patterns in usage and/or demand by businesses in certain industries. All records are searched in the fields for the types of data connections each company uses. These connections ranged from 56K up to multiple T3s. This information is parsed from the rest of the computer hardware information also contained in these fields, including LANs, WANs, switches, routers, etc. Due to the multitude of hardware types each company owns and utilizes, the database has multiple fields that represent all of the hardware owned by a company. There are also multiple separate fields that list the quantity of each piece of hardware owned by a company. Thus in order to derive a total quantity and type of data connection(s) used by a company, all hardware related fields are scanned for those pieces of equipment. The associated fields that contain the quantity of each are extracted. Once this was done, the resulting information is queried by SIC.

Consistency of the quantity and types of connections for businesses within the same SIC categories are then analyzed. Because the headquarter of a minor bandwidth industry, like restaurants, shows up as using multiple T1s, headquarters are treated as separate entities, to eliminate them from skewing the model.

Business records are then purchased from a business record database, such as Dun & Bradstreet (D&B) or American Business Information (ABI). These two companies maintain the most comprehensive data for businesses in the US and Canada, which is updated daily. Records are purchased based on market location and specific standard industry codes (SIC) of businesses that meet the bandwidth model. The main fields of interest for us include: company name, address, 4-digit SIC, branch/headquarter designation and employees. This data is pulled into GIS software, such as MapInfo, although this is not meant as a limitation, as any GIS software could handle this analysis. Once in MapInfo, a field is added to the database for Kbps per employee. The high bandwidth model has already estimated the number of Kbps each employee uses based on the IRG data. This number varies per SIC. Therefore all businesses in each individual SIC are assigned their respective bandwidth usage number. This number is then multiplied by the number of employees within that business. That value is put into a second field in the database, called Total Kbps. This value represents the total amount of bandwidth that is expected to be used by that company, per day.

Now, one knows which businesses within the market are prone to use high bandwidth, and can quantify their usage, based on the estimated Kbps just calculated. The present invention now needs to locate exactly where within the market each business is physically located. Due to the inherent problems with non-standard addresses (common in most databases), a program is created that cleans up the address fields (street address, apartment/suite, city, state, and zipcode). All data relating to addresses, be it business, building or residential, is run through this program. This affords common fields of information across data from very disparate sources. Once standard addresses are obtained, which businesses are located within the same building can be found. These addresses also allow linking of the individual business information from D&B to a real estate database of buildings, such as from COSTAR. COSTAR assigns a unique field per market to each building in its database contained in a field called “Seriel_”. COSTAR 's addresses also contain numerous inconsistencies and need to be run through the address cleaning program. The software not only creates new standardized address fields, it also creates latitude and longitude fields. These fields are populated using geocoding software such as MapMarker Plus.

However, these locations are not necessarily accurate. The databases and software used to geocode addresses, the means by which latitude and longitude coordinates are assigned based on address information, is as follows. The software program reads a list of addresses. These addresses are then matched based on the address, city, state and zipcode fields, to address information that is attributed to a street file. A street file is comprised of a multitude of polylines. Each polyline has one or more segments that are divided by nodes along that line. These individual segments within a line is what makes the file a polyline. Each polyline has attributed to it the street number and name. The data is assigned in ranges for each line. The database contains the following fields: FromLeft, ToLeft, FromRight, ToRight, Street. The FromLeft field will display the minimum address number for that street on the left side of the road, All odd number addresses are on one side and the even number addresses are on the opposite. The ToLeft field contains the maximum address number for the left side of the road. The FromRight and ToRight fields contain the minimum and maximum address numbers for the right side of the road. The Street field contains the name of the street. Another piece of data that is contained in the file is the length and location of the street. While not always visible in a database form, by being spatially linked in a GIS, these attributes are automatically associated to any object. So when the software scans the list of addresses and finds that it falls within a range of a street within it's streetfile, it then calculates the length of the street file that is associated to that range. Then it looks at the total number of addresses possible along that side of the road. It then assumes an even distribution of the address numbers along the street and selects a latitude and longitude that is associated with where the street number would fall along that street segment.

For example, there are 98 possible addresses between the range 100 and 198. There is an equal number of possible addresses between 101 and 199 on the other side of the road. All geocoding engines will take the total possible addresses and assume they are evenly spaced along the length of the street. The street length for this section is 0.1969 miles. That would put an address every 0.002 miles along that line; 0.1969 divided by 98. Realistically, most addresses that are assigned to streets are rarely completely built out. And if they are, they are not spread evenly along the length of the road.

Beyond the issue with latitude and longitude coordinates are assigned to addresses equally along the street, there are also geopositional accuracies of the street files that need to be addressed. Three different street files showing the same section of roads will probably have them appear in three different places on the same map. The street file accuracy varies between 50 to 250 feet. This has to do not only with the source of the street file, but also the projections in which each were created. This issue further distorts the actual location of the building.

These inaccuracies can be corrected by using a combination of orthophotographs and parcel maps. Raster images of parcel maps are obtained for all counties in the US. Approximately half of the counties have digital parcels. Any counties not having digital parcels, will require geographical location of the building using orthos and local market knowledge. Digital parcels are polygon boundaries created in a GIS that have attribute data linked to them. The attributed data includes address as well as zoning and land classifications. Parcel data includes address and zoning information for not only businesses, but also residential lots, as illustrated in FIGS. 10 and 12. The parcel data is layered on top of high resolution orthophotographs (orthos) of the market. The orthos allow precise location of the building as it is situated within the parcel lot. See FIGS. 15-17. This is done by visualizing the location of the building in the ortho relative to the parcel boundary.

The present invention now able to quantify the bandwidth and the number of target businesses by building. This is done by aggregating the individual business values up to each respective building. The aggregation of these values is done by grouping the individual businesses by address and zipcode. When this grouping is completed, the sums of businesses, employees, and bandwidth for each address is calculated. This information is what is added to the building file for each address. The new building file is then analyzed, spatially, in order to determine the concentrations of businesses within the market. This information is used to create target areas. These areas are what drives the engineering design of the broadband wireless network. These define the places in the market where the target subscribers are located so as to allow target marketing. It also assists in identifying buildings that would make the best hub locations, based on: multiple target businesses within the building; the building being within line of sight of a hub; the building being within propagation distance from a hub; and minimal, if any, existing competition.

A system and method of analyzing a market for the implementation of a broadband wireless network has been shown. It is obvious to one skilled in the art that this system and method may be used for optimizing a variety of network designs, and is not particular to communication systems. It is also worth noting that individual pieces of this system have strengths unto their own and can be utilized outside of the context of designing any network architecture; i.e., incorporated in e-commerce, B2B industry, IT businesses, etc.

I claim:

1. A broadband wireless network implementation process, comprising:
developing a profile of high bandwidth users in a market area based on available marketing information from said market area;
checking said profile for accuracy;
revising said profile until a desired accuracy level is obtained;
obtaining addresses for all buildings in said market area;
cross-referencing said addresses with a high resolution orthophotographic database to identify precise building locations;
overlaying a layer of existing and planned competitive broadband services for said market area in a geographic information system (GIS); and
identifying target areas for broadband wireless services (WBS).

2. The broadband wireless network implementation process of claim 1, further comprising calculating optimal tower placement for providing WBS to said target area.

3. The broadband wireless network implementation process of claim 2, further comprising:
calculating a cost of said optimal tower placement for providing WBS to said target area;
counting predicted customers within said target area; and
calculating an average price for service.

4. The broadband wireless network implementation process of claim 3, wherein said developing a profile of high bandwidth users in a market area further comprises analyzing business and bandwidth usage databases to identify criteria of high bandwidth users.

5. The broadband wireless network implementation process of claim 3, wherein said checking said profile for accuracy further comprises surveying businesses matching said profile in said market area for interest in broadband services.

6. The broadband wireless network implementation process of claim 3, wherein said desired accuracy level is greater than or equal to 85%.

7. The broadband wireless network implementation process of claim 3, wherein a real estate database is used for said obtaining of addresses for all buildings in said market area.

8. The broadband wireless network implementation process of claim 7, wherein said real estate database further includes longitude and latitude for all buildings in said market area that is corrected with said high-resolution orthophotographic database.

9. The broadband wireless network implementation process of claim 3, further comprising determining height and shape of buildings and line-of-sight obstructions in said market area using canopy digital elevation model (DEM) data.

10. The broadband wireless network implementation process of claim 3, further comprising identifying potential hub buildings in said market area.

11. The broadband wireless network implementation process of claim 3, wherein said information on existing and planned competitive broadband services for said market area includes wireless service competition, broadband landline competition, and ISP service.

12. The broadband wireless network implementation process of claim 11, wherein information on existing and planned wireless service competition is obtained from real estate investment trust (REIT) agreements, monitoring public records, Federal Communications Commission (FCC) filings, radio Frequency (RF) emission databases, and site surveys.

13. The broadband wireless network implementation process of claim 11, wherein information on existing and planned broadband landline service competition is obtained by locating central offices of digital subscriber line (DSL) providers to determine coverage area, determining coverage regions of cable providers, and determining on-net fiber optic probability of all buildings in the market area based on NPA/NXXs serviced by competitive local exchange carriers (CLECs) or a number of individual switch codes for incumbent local exchange carriers (ILECs).

14. A method of planning and designing a broadband wireless network, comprising:
analyzing a business bandwidth usage database for usage trends or patterns by standard industry code (SIC) to identify target SICs;
searching a business record database for target businesses in a market area based on having said target SICs and importing a business name, address, 4-digit SIC, branch/headquarter description, and number of employee field for each of said target businesses into a geographic information system (GIS);
standardizing each said address field by parsing it into street address, suite/apartment number, city, state, and zip code fields and adding a longitude and latitude field;
identifying a building for each business based on said street address field;
correcting said longitude and latitude fields in said GIS using orthophotographic images and raster image parcel maps of said market area; and
quantify bandwidth and number of target businesses per building to determine target areas based on a concentration of target businesses.

15. The method of planning and designing a broadband wireless network of claim 14, wherein headquarter businesses are treated and targeted differently than branch businesses of the same SIC.
